(19) United States
(12) Patent Application Publication
(10) Pub. No.: US 2009/0015928 A1
(43) Pub. Date: Jan. 15, 2009

(54) METHOD FOR THE DEFORMATION OF SURFACES AND ARTICLES FORMED THEREBY

(76) Inventors: Alfred Crosby, Amherst, MA (US); Patricia Wadsworth, Amherst, MA (US); Jessica Zimberlin, Amherst, MA (US)

Correspondence Address: CANTOR COLBURN, LLP, 20 Church Street, 22nd Floor, Hartford, CT, 06103, US

(21) Appl. No.: 12/170,182

(22) Filed: Jul. 9, 2008

Related U.S. Application Data
(60) Provisional application No. 60/948,614, filed on Jul. 9, 2007.

(51) Int. Cl. G02B 27/10; B29D 11/00

(52) U.S. Cl. 359/622; 216/26

(57) ABSTRACT

A method of deforming a surface comprises exposing a composite article to a plurality of biological contractile cells, wherein the composite article comprises a substrate comprising a depression formed on a surface thereof; and a deformable layer having a first surface and an opposite, second surface, wherein the first surface of the layer is adheringly disposed on the surface of the substrate, and a portion of the layer covers the depression; and wherein the exposure is for a length of time and under conditions effective for the biological contractile cells to adhere to the second surface of the layer and deform the portion of the second layer covering the depression.

### STATEMENT REGARDING FEDERALLY SPONSORED RESEARCH & DEVELOPMENT

The U.S. Government has a paid-up license in this invention and the right in limited circumstances to require the patent owner to license others on reasonable terms as provided for by the terms of Contract No. DGE-0504485 awarded by NSF-IGERT.

### BACKGROUND

Surface deformation, for example buckling or wrinkling, can be generated in a variety of systems. Such systems include thermally or mechanically stressed metallic, polymeric, and silicate thin films supported on elastomeric substrates; dried thin films prepared by sol-gel methods; and soft gels placed under geometric confinement that are swollen or dried. However, new systems are constantly being sought, in particular systems that can provide surface relief structures in a variety of materials. It would further be advantageous if the systems allowed easy and flexible pattern formation.

### BRIEF DESCRIPTION OF THE INVENTION

A method of deforming a surface comprises exposing a composite article to a plurality of biological contractile cells, wherein the composite article comprises a substrate comprising a depression formed on a surface thereof; and a deformable layer having a first surface and an opposite, second surface, wherein the first surface of the layer is adheringly disposed on the surface of the substrate, and a portion of the layer covers the depression; and wherein the exposure is for a length of time and under conditions effective for the biological contractile cells to adhere to the second surface of the layer and deform the portion of the second layer covering the depression.

A method of forming a microlens array comprises exposing a composite article to a plurality of contractile biological cells, wherein the composite article comprises a optically transparent substrate comprising a plurality of depressions having a substantially circular cross section formed on a surface thereof; and an optically transparent layer having a first surface and an opposite, second surface, wherein the first surface of the layer is adheringly disposed on the surface of the substrate, and a portion of the layer covers the plurality of depressions; and wherein the exposure is for a length of time and under conditions effective for the contractile cells to adhere to the second surface of the layer and deform the portion of the second layer covering the depression to form the microlens array.

A composite article, comprises a substrate comprising a depression formed on a surface thereof; a layer having a first surface and an opposite, second surface, wherein the first surface of the layer is adheringly disposed on the surface of the substrate, and a portion of the layer covers the depression, and the second surface has a surface structure formed thereon; and contractile cells contacting the second surface of the layer, wherein the contraction of the cells forms the surface structure.

The above described and other features are exemplified by the following figures and detailed description.

### BRIEF DESCRIPTION OF THE DRAWINGS

The invention is further illustrated by the following exemplary Figures wherein like elements are numbered alike.

FIGS. 1a-e is a schematic representation of a method for forming a microlens as described herein.

FIG. 2 is a low magnification differential interference contrast (DIC) image of an example of an array of microlenses formed by fibroblasts (scale bar 50 micrometers).

FIGS. 3a-e show (a) a low magnification DIC image of a microlens formed by fibroblasts, focused on the top of the lens, with microlens diameter of 400 micrometers; (b) a set of confocal images of individual microlenses formed by fibroblasts, with scale bar of 200 micrometers; (c) a series of confocal images of microlenses formed by epithelial cells, both top view z-stack, increasing steps from the surface to the top of the microlens in z-space; and side profile, viewed from the side cut from the middle of the lens, with scale bar of 50 micrometers; (d) a graph of the height development of four microlenses; initial radii noted in the legend in micrometers; and (e) a graph of the final microlens height based on the initial well radius for lenses formed by endothelial cells and fibroblasts; the trend lines are fits using strain values of 0.0055 and 0.0031 respectively. Data points (A) and (B) have well depths of 325 micrometers and 275 micrometers respectively.

FIG. 4a-e shows the effect of the loss of cell/cell junctions in an epithelial cell sheet in (a) an image of cadherin stained epithelial cells; (b) an image of cadherin stained fibroblast cells; (c) a graph of height change of individual microlenses after being in a calcium-free environment; (d) and (e) are projection images both looking down and from the side before, (d), and after, (e), calcium depletion. The scale bar for (a) and (b) is 1 micrometer and for (d) and (e) is 200 micrometers.

FIG. 5 is a strain graph versus height (h)/initial radius (aₒ) of cells adhered to a deformable surface.

FIG. 6 is a graph of final lens height showing the effect of different cell types.

FIG. 7 is a graph showing the cytoskeletal response of nocodazole (N) and nocodazole/Latructin (N/L) treatment on cells as reflected by lens height before and after treatment.

FIG. 8a-d show (a) a bar chart of height changes of microlenses after addition of drug treatment, where the smaller bars are individual samples within a larger average bar; (b) a graph plotting eight profiles of two microlenses of the epithelial cells before (gray) and after (black) treatment with latrunculin B; (c) a graph plotting eight profiles of two microlenses of the epithelial cells before (gray) and after (black) treatment with nocodazole; and (d) a topographic display of a microlens of fibroblasts that have been treated with nocodazole. Local areas of high strain can be seen as smaller peaks on the microlens.

FIGS. 9a-c shows projection images of the word ‘UMASS’ as produced by two microlenses; (a) is an illustration of the experimental setup with images projected through a lens produced by fibroblasts (b) and epithelial cells (c). The scale bar is 200 micrometers.

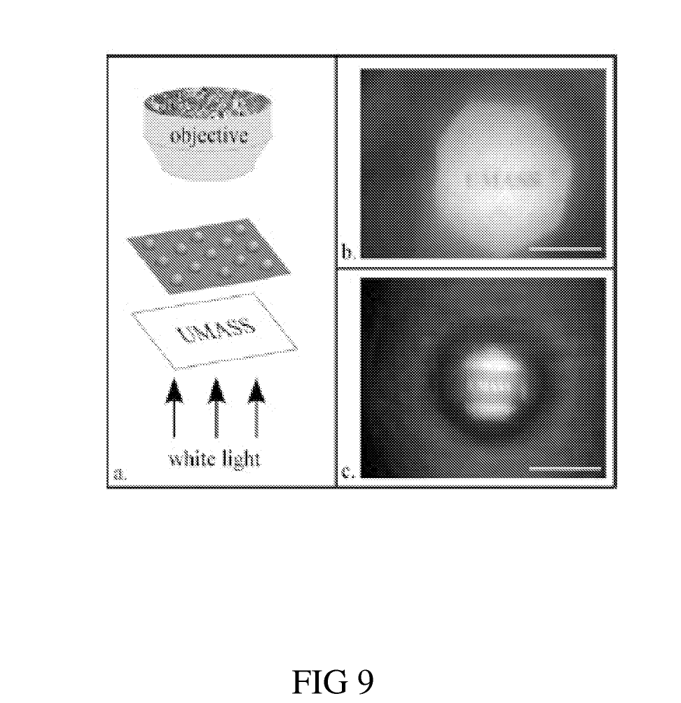

### DETAILED DESCRIPTION OF THE INVENTION

The present inventors have demonstrated a novel method for generating surface deformations on a micrometer scale using a biological system. This approach is amenable to creating a single deformation, or relief patterns on a variety of polymer systems. The method can be used to yield a wide variety of functional articles, including, for example, microlenses, microlens arrays, compound microlenses, artificial compound eyes comprising microlens arrays and/or compound microlenses, diffraction gratings, pressure-sensitive adhesives, mechanical strain sensors, microfluidic devices, photonic crystals, and cell culture containers.

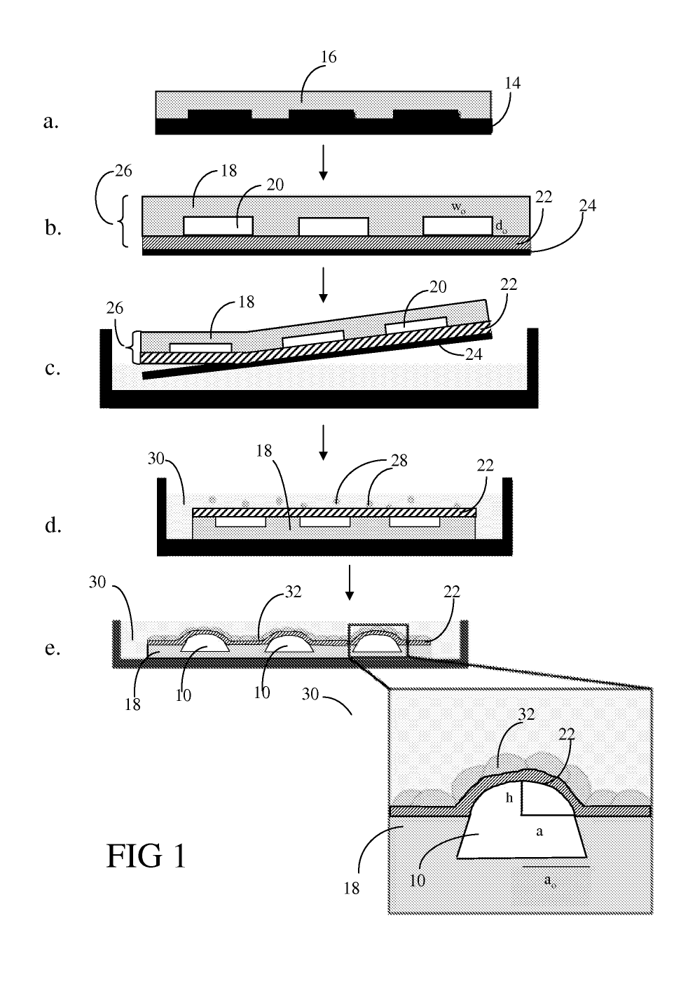

FIG. 1 illustrates the method of forming a plurality of microlenses 10. It is to be understood that the following discussion, while directed to formation of a microlens, is generally applicable to generation of a variety of shapes, and is further useful to form a single deformation or an array of deformations.

In the embodiment shown in FIG. 1, a crosslinkable polymer is coated on a relief surface of mold 14, such as an imaged and etched silicon wafer, to form polymer layer 16 (FIG. 1a). The polymer layer 16 is then cured to form a substrate 18 (shown in FIG. 1bb) and comprising, after separation from mold 14, a surface having depressions 20 conforming to the relief surface of mold 14. The shape and the dimensions of the depressions 20 in substrate 18 will be dictated by the particular use of the article. In one embodiment, the substrate 18 is a layer that has a thickness of about 10 to about 20,000 nanometers, specifically about 20 to about 2000 nanometers.

The depressions 20 can have any desired shape, for example columnar, cubic, conical, frustoconical, pyramidal, hemispherical, toroidal, and the like. In one embodiment, as shown in FIG. 1, the depressions 20 are columnar, with a circular cross-section. Other possible cross sections include square, triangular, oval, rhomboidal, rectangular, hexagonal, or other polygonal shape, and the like. The shape and dimensions of the depression(s) 20 can vary widely, and will be dictated by the end use of the article. An article can contain a single shape and size of depressions, or a plurality of shapes and/or sizes, again depending on the end use of the article.

In one embodiment, the depression has an initial average largest width (wₒ) of 1 micrometer to 1 millimeter (FIG. 1b). The depression can also have an initial average largest depth (dₒ) of 10 nanometers to 1 millimeter. Where the depression is substantially circular in cross section, the depression can have an initial equivalent circular diameter (2×aₒ) of 1 micrometer to 1 millimeter.

The distribution of the depression(s) 20 will determine the distribution of the deformations in the article. The deformations can be formed in any pattern, for example a random pattern or a regular pattern such as a line, circle, grid, and the like. The percentage of the surface that contains a depression can vary from about 0.1 to 99 area percent of the surface, specifically about 5 to about 90 area percent, more specifically about 10 to about 80 area percent, even more specifically about 20 to about 70 area percent, still more specifically about 40 to about 60 area percent of the surface, specifically about 5 to about 90 area percent, more specifically about 10 to about 80 area percent, even more specifically about 20 to about 70 area percent, still more specifically about 40 to about 60 area percent.

Alternatively, the depressions can be formed by any suitable method, for example, molding, drilling, use of a mask and an etchant, for example a chemical etchant, and the like. When a polymer is molded onto an array of posts to form an array of depressions as in FIG. 1a, the array can contain depressions of varying radii aₒ.

As shown in FIG. 1, a deformable layer 22 is then fixedly attached to a surface of the substrate 18 covering at least one depression 20 to form a bilayer 26. The deformable layer 22 is generally in the form of a thin film, as the deformable layer 22 will be deformed upon attachment of the cells. In one embodiment the deformable layer 22 is about 10 to about 2000 nanometers thick, specifically about 20 to about 1000 nanometers thick.

Layers of the appropriate thickness can be formed by a variety of methods, and there is no particular limit on the method used. In some embodiments, the deformable layer 22 is formed on a second substrate 24, such as a glass slide, by, for example, casting a polymer composition that subsequently cures (as, for example, with a polysiloxane), by solvent casting a polymer composition, by spin coating, by molding, or the like. Other features can be formed into the layers as dictated by the end use of the article, provided that such features do not substantially interfere with deformation of the layer. In one embodiment, the portion of the film that covers the depressions is thinner or thicker than the portions of the film in contact with the substrate.

A wide variety of materials can be used to form the substrate 18 and the deformable layer 22. In one embodiment, the substrate and the layer each has an elastic modulus, wherein the elastic modulus of the substrate 18 is lower than or equal to the elastic modulus of the deformable layer 22. The elastic modulus of the substrate 18 can be, for example, from about 0.1 kilopascal to about 10 megapascals at 25° C. The elastic modulus of the deformable layer 22 can be, for example, from about 0.1 kilopascals to about 10 gigapascals at 25° C.

Exemplary polymeric materials for the substrate and deformable layer include, for example, a poly(acetal), poly(acrylic), poly(carbonate), poly(ester-carbonate), poly(styrene), poly(arylene ether), poly(ethylene), poly(propylene), poly(amide), poly(amide imide), poly(ether imide), poly(arylate), ethylene propylene diene rubber, ethylene propylene diene monomer rubber, poly(sulfone), poly(ether sulfone), poly(perfluoroalkoxyethylene), poly(ether ketone), poly(ether ether ketone), poly(ether ketone ketone), liquid crystalline polymer, poly(urethane), natural rubber, synthetic rubber, epoxy, phenolic, poly(ester), poly(diorganosiloxane), poly(alkyl (meth)acrylate, poly(conjugated diene), block copolymer of an alkenyl aromatic monomer and a conjugated diene, or a combination comprising at least one of the foregoing.

Specific polymeric materials include a styrene-acrylonitrile copolymer, acrylonitrile-butadiene-styrene copolymer, poly(bisphenol A carbonate), poly(ethylene terephthalate), poly(butylene terephthalate), poly(amide), poly(aryl sulfone), poly(phenylene sulfide), poly(vinyl chloride), poly(tetrafluoroethylene), fluorinated ethylene-propylene copolymer, poly(perfluoroalkoxyethylene), poly(chlorotrifluoroethylene), poly(vinylidene fluoride), poly(vinyl fluoride), poly(phenylene ether), poly(ester-carbonate), poly(phenylene sulfide), poly(ethylene), poly(dimethylsiloxane), poly(methyl (meth)acrylate, poly(butadiene), or a combination comprising at least one of the foregoing polymers.

Even more specifically, the substrate comprises a poly(dimethyl)siloxane, a poly(alkyl(meth)acrylate), a poly(conjugated diene) such a poly(butadiene), a copolymer of an alkenyl aromatic monomer and a conjugated diene, or a combination comprising at least one of the foregoing polymers. The deformable layer comprises poly(styrene).

The materials can be selected so as to provide increased cellular adhesion to the deformable layer compared to the substrate. In the alternative, or additionally, the deformable layer is treated so as to enhance cellular adhesion. Such treatment methods generally comprise surface modifying techniques, for example exposing the outer surface of the deformable layer to ultraviolet light, exposing the surface to gamma radiation, exposing the surface to an electron beam, exposing the surface to ozone, exposing the surface to an oxygen plasma, exposing the surface to chemical vapor deposition, or combinations thereof. Selection of the surface modifying technique will depend on factors including the identity of the deformable layer.

Bi-layer 26 can be floated in a medium to separate the second substrate 24 from deformable layer 22 (FIG. 1c). In some embodiments, modifying the surface of deformable layer comprises exposing the surface to oxygen plasma after separating the deformable layer from the second substrate as shown in FIG. 1c. Inverting bi-layer 26 orients the deformable layer 22 on top for subsequent treatment with contractile cells 28 (FIG. 1d).

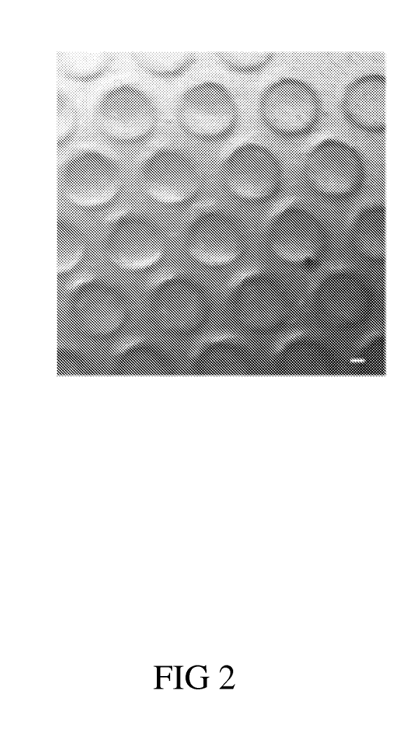

The composite is then exposed to contractile cells 28 to form cell layer 32 in a culture medium 30 (FIG. 1d). As used herein, “contractile cells” includes cells that contract upon adhesion to a substrate, here the deformable layer; that contract in a natural rhythm, e.g., cardiac cells; and/or that can be induced to contract upon exposure to an environmental change, for example a change in pH or exposure to a contractile material. For example, it is known in the field of cell biology that when a cell adheres to a surface it exhibits traction forces due to the contractile nature of the cells. Suitable cell lines of this type include NIH/3T3 mouse fibroblasts and LLC-Pk1 epithelial cells. Certain Cells such as cardiac cells, which contract and relax in a natural rhythm, can be adhered to the deformable layer and reversibly deform the layer in their natural rhythm. Alternatively, cells can be adhered to the deformable layer 22 and induced to contract upon a change in environment, for example a change in pH or exposure to a chemical material that affects the degree of contraction of the cell. The deformation of layer 22 caused by the cell layer 32 produces an array of microlenses 10 (FIG. 1e). FIG. 2 illustrates an array of microlenses formed by fibroblasts (scale bar 50 micrometers)using the above-described process.

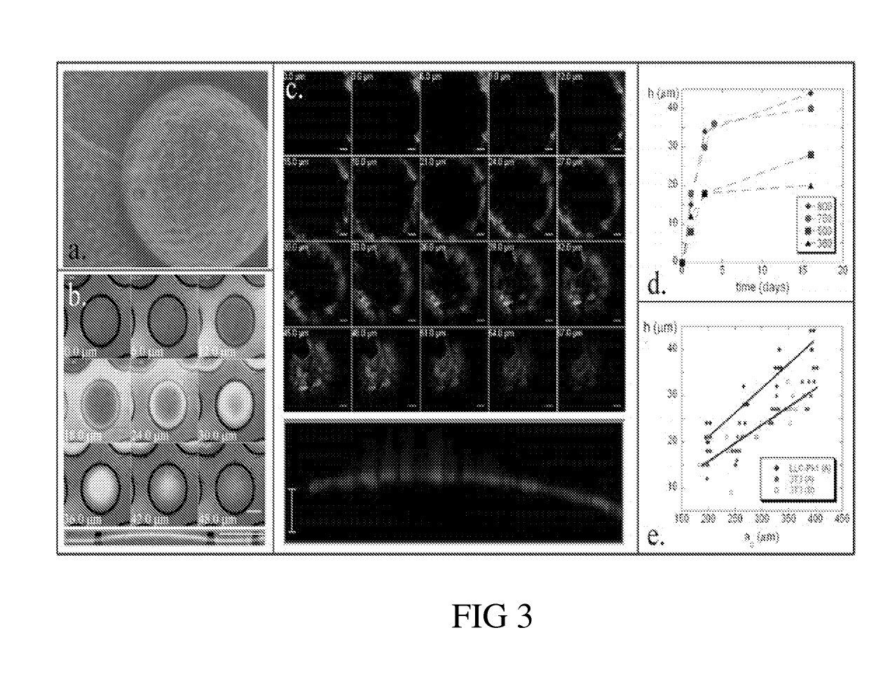

FIGS. 3a-c are additional images of the microlenses. FIG. 3a is a low magnification differential interference contrast (DIC) image of a microlens formed by fibroblasts, focused on the top of the lens. The microlens has a diameter of 400 micrometers. FIG. 3b is a set of confocal images of individual microlenses formed by fibroblasts. The scale bar is 200 micrometers. FIG. 3c shows confocal images of a composite wherein the deformable layer 22 has been deformed by the adhesion of LLCPK epithelial cells. FIG. 3c shows the LLCPK epithelial cells plated onto a polystyrene deformable layer disposed on a poly(dimethylsiloxane) substrate after the cells had reached confluency. The first picture was taken arbitrarily at 0 micrometers, and the image moved up in z-space. The overall curvature can be seen in the side profile image of FIG. 3c (bottom image). The scale bar in FIG. 3c is 50 micrometers.

FIGS. 3d-e graphically represent the height development of the microlenses. FIG. 3d shows the height development of four microlenses with initial radii noted in the legend in micrometers. Rapid height development was observed in the first four days. Substantially less height development occurred between 5 and 15 days. FIG. 3e shows height development of microlenses based on the initial well radius formed by endothelial cells and fibroblasts. The trend lines are fits using strain values of 0.0055 and 0.0031 respectively. Data points (A) and (B) have well depths of 325 micrometers and 275 micrometers respectively.

The degree of deformation of the cells can be adjusted; substantially or completely reversed; or rendered permanent. In one embodiment, the method further comprises adjusting a degree of deformation of the deformable layer 22 during deformation of the deformable layer or after deformation of the deformable layer. In another embodiment, adjusting the degree of deformation of the deformable layer 22 comprises substantially reversing the deformation of the deformable layer. Adjusting or reversing the degree of deformation can be by exposing the contractile cells to an environmental change effective to modify a degree of contractile ability of the cells, for example an alteration in pH, a change in temperature, a change in the makeup of the cell medium, or exposure to a specific chemical substance. It is known that where the cells comprise a plurality of actin filaments, the contractile ability of the actin filaments can be modified (i.e., the actin depolymerized) by exposure of the cells to latructin. Where the cells comprise a plurality of microtubules, the contractile ability of the microtubules can be modified (i.e., the microtubules depolymerized) by exposure to nocodazole. Return of the environment to its original condition can then be used to effect a re-contraction of the cells, and a re-deformation of the deformable layer.

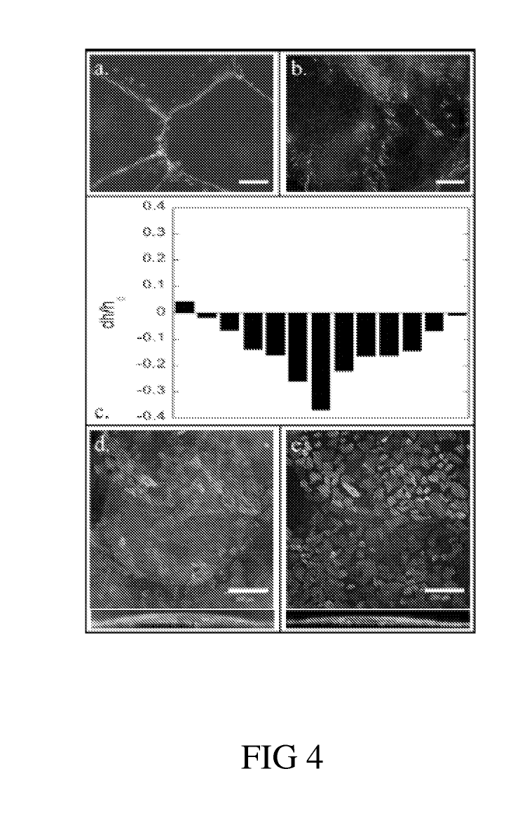

Disrupting the cell/cell junctions can also affect the shape of the microlens. The cell/cell junctions can be disrupted, for example, by treating the cells with calcium-free phosphate buffered saline, to disrupt cell-cell adhesion via cadherins. The amount of strain exerted by the cells with depleted junctions is observed as a decrease in microlens height. FIG. 4a-e shows the effect of the loss of cell/cell junctions in an epithelial and fibroblast cell sheets. FIG. 4a is an image of cadherin staining for epithelial cells and FIG. 4b is an image of cadherin staining for fibroblast cells. The scale bar in FIGS. 4a-b is 1 micrometer. FIG. 4c is a graph of height change of individual microlenses after being in a calcium-free environment. FIGS. 4d and 4e are projection images both looking down and from the side before, (d), and after, (e), calcium depletion. The scale bar in FIGS. 4d-e is 200 micrometers.

Alternatively, the deformation can be rendered permanent, for example by fixing the cells in cell layer 28, or by crosslinking the deformable layer 22, the substrate 18, or both. In one embodiment, the deformable layer 22 comprises a crosslinkable polymer, and rendering the surface deformation permanent comprises crosslinking the crosslinkable polymer after deforming the layer. The crosslinking comprises physical or chemical crosslinking. In chemical crosslinking, the deformable layer 22 can comprise, for example, ethylenically unsaturated groups such as a (meth)acryloyl group, a vinyl group, an allyl group, or a combination thereof. The crosslinkable polymer can further comprise a crosslinking agent, or the crosslinking agent can be added to the cell medium. The crosslinking agent can be an alkenyl aromatic monomer, (meth)acrylate monomer, alkenyl ether monomer, or a combination comprising at least one of the foregoing, specifically an n-butyl acrylate and/or ethylene glycol dimethacrylate. Crosslinking can be accomplished by heating the crosslinkable polymer, exposing the crosslinkable polymer to ultraviolet light, exposing the crosslinkable polymer to gamma radiation, exposing the crosslinkable polymer to an electron beam, exposing the crosslinkable polymer to x-rays, or a combination thereof.

Articles formed by the above methods included, for example, a microlens, a microlens array, a compound microlens, a diffraction grating, a photonic crystal, a pressure-sensitive adhesive, a sensor such as a mechanical strain sensor, a microfluidic device, e.g., a pump, and a cell culture container. Diffraction gratings prepared by different techniques are described in, for example, N. Bowden, W. T. S. Huck, K. E. Paul and G. W. Whitesides, Applied Physics Letters, 1999, vol. 75, pages 2557-2559. One-dimensional photonic crystals are described in, for example, Stephen G. Johnson, “Photonic Crystals: Periodic Surprises in Electromagnetism”, available at http://ab-initio.mit.edu/photons/tutorial/(last visited Nov. 20, 2006); and S. G. Johnson and J. D. Joannopoulos, Photonic Crystals: The Road from Theory to Practice (Kluwer, 2002). Specifically, the one-dimensional wrinkles (ribbons) described herein may create a one-dimensional photonic crystal. Surface structures suitable for use as pressure-sensitive adhesives are described in, for example, A. J. Crosby, M. Hageman and A. Duncan, Langmuir, 2005, vol. 21, pages 11738-11743. Mechanical strain sensors are described in, for example, C. M. Stafford, C. M. Harrison, K. L. Beers, A. Karim, E. J. Amis, M. R. Vanlandingham, H.-C. Kim, W. Volksen, R. D. Miller and E. E. Simonyi, Nature Materials, 2004, vol. 3, pages 545-550. Microfluidic devices are described in, for example, S. Jeon, V. Malyarchuk, J. O. White and J. A. Rogers, Nano Letters, 2005, vol. 5, pages 1351-1356. Cell culture surfaces are described in, for example, C. D. W. Wilkinson, A. S. G. Curtis and J. Crossan, J. Vac. Sci. Technol. B, 1998, vol. 16, pages 3132-3136; and M. Yamato, C. Konno, M. Utsumi, A. Kikuchi and T. Okano, Biomaterials, 2002, vol. 23, pages 561-567.

In a specific embodiment a method of forming a microlens array, comprises: exposing a composite article to a plurality of contractile cells, wherein the composite article comprises optically transparent substrate comprising a plurality of depressions having a substantially circular cross section formed on a surface thereof; and an optically transparent layer having a first surface and an opposite, second surface, wherein the first surface of the layer is adheringly disposed on the surface of the substrate, and a portion of the layer covers the plurality of depressions; and wherein the exposure is for a length of time and under conditions effective for the contractile cells to adhere to the second surface of the layer and deform the portion of the second layer covering the depression to form the microlens array.

The invention is further illustrated by the following non-limiting examples.

### EXAMPLE

In order to create the adaptable microlenses, the following approach as illustrated in FIG. 1 was used. A surface of crosslinked poly(dimethyl siloxane) (PDMS) substrate comprising microwells (depressions) was prepared from a mold comprising an hexagonal array of photolithographic posts. A thin film of polystyrene (PS), 735 nm, is placed on top of the PDMS microwells and oxygen plasma treated to make the surface more favorable to cell growth. Two different cell types were used: NIH/3T3 mouse fibroblasts, NIH/3T3 mouse fibroblasts that were developed to stably express GFP-actin binding sites, and LLCPK1 epithelial cells that were developed to stably express GFP-actin fluorescence.

### Methods:

Fabrication of Molds: Photolithography. An SU-8 2100 negative photoresist (Microchem) was spin-coated onto a silicon wafer at 1000 rpm, spin time was varied for varied feature height of 325 or 275 micrometers. The resist was prebaked for 20 minutes at 90° C. and then exposed for 55 seconds (OAI 500W DUV, intensity=20 mJ/cm²) with a mask of circles of varying radii from 200 to 400 micrometers. The resist was when postbaked for 1 minute at 90° C. and developed in SU-8 developer (Microchem) to reveal hexagonal arrays of posts.

Fabrication of Surfaces: Crosslinked poly(dimethylsiloxane) (PDMS) was prepared by mixing Dow Coming Sylgard 184 with catalyst and degassing for 15 minutes. The PDMS was coated on the imaged silicon wafer prepared via photolithography and cured at 70° C. for three hours to produce upon separation from the silicon wafer a PDMS film substrate comprising an array of microwells . These PDMS films were then placed depression side down onto thin films of PS that were prepared by spin-coating a PS/toluene solution at 4000 rpm for 30 seconds onto glass slides that had been UV-Ozone (Jelight UVO cleaner, 342) treated for 5 minutes. The thickness of the polystyrene films was measured with an interferometer. The PS/PDMS pair was floated off onto DI-water and placed onto glass bottom culture dishes (MatTek), PS face up. The substrates were then UV-Ozone or oxygen plasma treated (Harrick Plasma Cleaner, PDC-001) for 8 minutes to increase the hydrophilicity of the surface. When substrates were made for experiments using the fibroblasts, 2.5 mg/mL of rubrene (Aldrich) was added to the PS/toluene solution to make the surface fluorescent.

Cell Culture and Reagents: NIH/3T3 mouse fibroblasts were cultured in Dulbecco's modified Eagle's medium (DMEM) containing 10% calf serum and 1% penicillin/streptomycin (P/S) solution. LLC-Pk1 epithelial cells and LLC-Pk1 epithelial cells that constitutively express GFP-actin were cultured as described previously (Murthy and Tulu, 2005). Cells were treated with inhibitors by adding either a 5 micromolar solution of latrunculin B (Biomol) or a 33 micromolar solution of nocodazole (Biomol), both in culture media, to the system.

Immunofluorescence Staining and Image Acquisition: Cells were fixed for 10 min in −20° C. methanol, rehydrated in PBS containing 0.1% Tween-20 and 0.02% sodium azide and stained. The primary antibody used was monoclonal anti-pan cadherin (Sigma clone CH-19; 1:500 dilution). Primary staining was followed by incubation in Cy3-labeled goat antimouse (Jackson Immunoresearch, West Grove, Pa.; 1:400 dilution) secondary antibody. Cells were mounted in Vectashield (Vector laboratories, Burlingame, Calif.) and sealed with nail polish. Cells were observed on a Nikon Eclipse TE 2000-S inverted microscope with a 100×, oil immersion objective lens. Images were acquired with a Qimaging camera, Micro-Manager 1.1 software through imageJ, and an electronic shutter, Lambda S.C., (Sutter Instrument, Novato, Calif.). A standard filter cube was used for the Cy3 fluorescence.

Measurement of Microlens Properties: The height of the formed microlenses was measured the confocal images from the Zeiss Confocal. Excess media was removed and a glass cover slip was placed over the system so it could be inverted and imaged. Space between the coverslip and the top of the microlenses was fixed to ensure the two surfaces were not touching. Culture media filled the gap.

Although these procedures include specific details for materials and geometry, a wide range of parameters will accomplish this general strategy.

The primary advantage of this method over other models is based upon the living nature of the deformation, for example the microlenses formed. Because it is the cells that dictate the final curvature of the lenses, the use of different cells with a different contractile nature will form lenses with different focal lengths. The buckling of the thin PS layer is an observed preference for the assembly to accommodate the applied in-plane strains exerted by the cell sheet. This development of out-of-plane bending minimizes the in-plane strains, thus the height of the microlens can be estimated by balancing the applied strains with the deformed configuration of the PS/PDMS assembly. Assuming conservation of area in the synthetic assembly and that the initially planar area forms a perfectly spherical cap upon buckling, then the ratio of the microlens height, h, to the initial radius of the microwell (depression), aₒ, is proportional to the applied strain, εepsilon:

h/aₒ=(episolon(2+epsilon))^{1/2} (1)

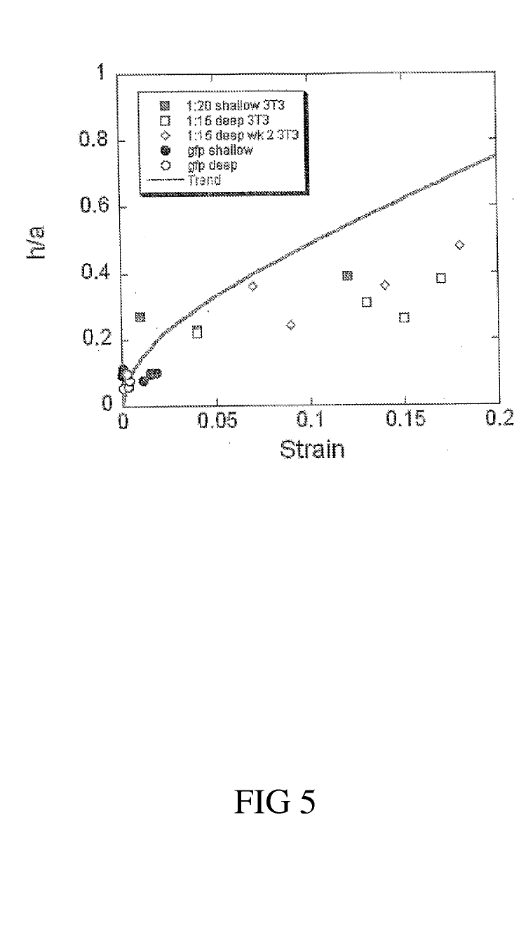

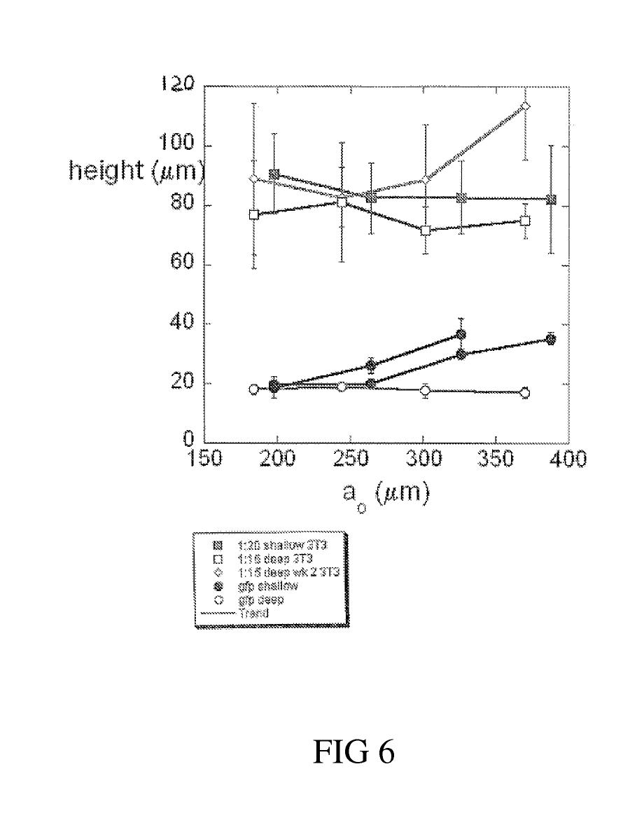

Therefore, higher strains applied to the substrate by the cell sheet lead to microlenses of greater aspect ratios (h/aₒ). The development of strain is demonstrated through the increase in microlens height as a function of time (FIG. 3d). The kinetics of microlens development is dictated by the growth kinetics related to confluent cell sheet formation. After confluency is achieved, the microlens height approaches a final, steady state value. Plotting final h versus aₒ, and using equation (1) (FIG. 3e), the average final strain values were determined to be 0.0055 and 0.0031. The difference in strain is shown graphically in FIG. 5, which compares microlenses developed by the more NIH/3T3 fibroblasts with microlenses developed by the LLCPK epithelial cells. The fibroblasts develop a greater strain on the surface compared to the epithelial cells. This greater development of strain therefore results in microlenses of greater lens height, observed in FIG. 6, (“μm” means micrometer in FIG. 6).

In these experiments, the lateral stiffness of the assemblies is nearly constant, thus differences in applied contractile forces produce different strain values. The different strains developed by the respective cell types are unexpected based on prior art showing single fibroblasts were shown to produce higher traction forces on a substrate than epithelial cells. Without being bound by theory, the examples herein support the hypothesis that as the number of each cell type increases on a given substrate there is a crossover from the single fibroblast exerting more traction forces to the collective nature of epithelial cells exerting higher stresses. One possibility is that the greater force generated by the epithelial cells results from the relatively tight binding of epithelial cells to their neighboring cells in the epithelial sheet, via zonula adherens junctions. These adherens junctions are linked to the intracellular actin network by various accessory proteins that bind to junctional components and the cytoskeleton. Immunofluorescence staining for cadherin shows intense and uniform staining between epithelial cells, but only patchy staining between fibroblasts (FIG. 4). Upon cellular contraction, the greater number of junction points in epithelial, as compared to fibroblasts (FIGS. 4a and 4b), leads to the transmission of greater stress to the surface.

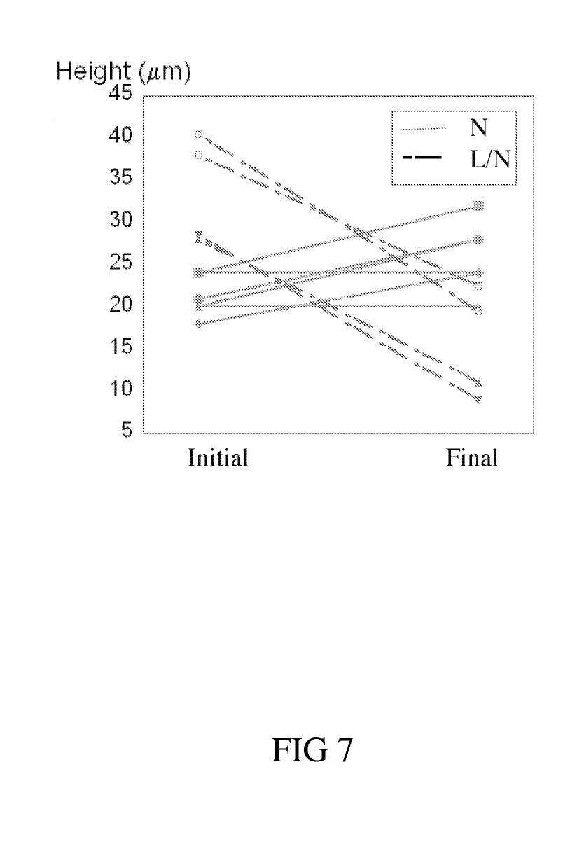

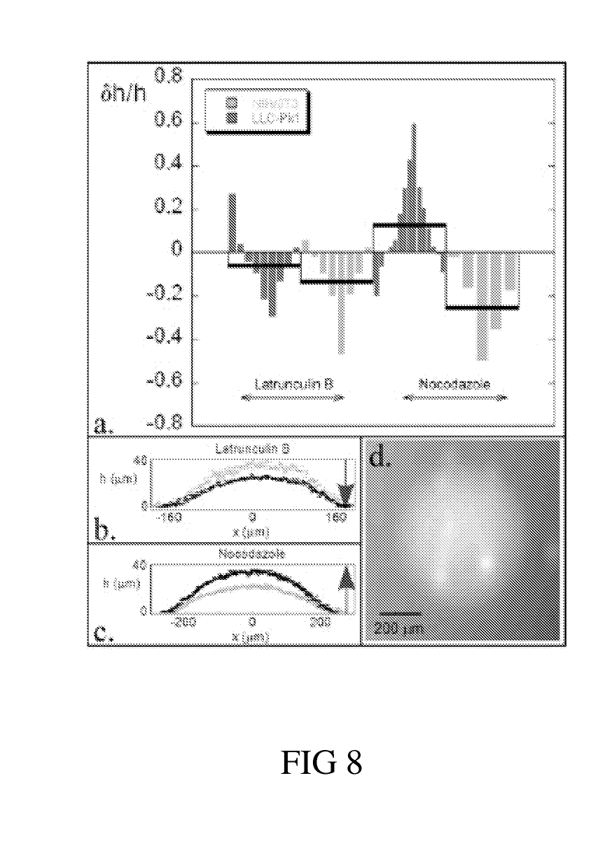

The living nature of the microlenses by controlling and modifying their final height is shown in FIGS. 7. In FIG. 7, the height of the LLCPK microlenses is modified using two different chemical stimuli. By introducing a solution of nocodazole to the system, the microtubules that act as the cells internal struts are depolymerized. This then allows the cells to contract further, and a relative height increase to the microlenses is seen as shown in FIG. 7. In a similar manner, by using a combination of nocodazole and latrunculin, which depolymerizes the actin filaments that are responsible for the contraction of the cells, the cells relax as their internal mechanical networks are destroyed and the height of the microlenses decreases. FIG. 8a graphically compares the height change of microlenses formed by NIH/3T3 fibroblasts and LLC-Pk1 epithelial cells after latruculin B and nocodazole treatments, where the smaller bars are individual samples within a larger average bar. The microlenses formed by fibroblasts lost height in both treatments, whereas the microlenses formed by the epithelial cells increased height on treatment with nocodazole, and lost height on treatment with latrunculin B. FIGS. 8b-c show the height profiles of two microlenses formed by epithelial cells before (gray) and after (black) treatment with latrunculin B, FIG. 8b, and nocodazole, FIG. 8c. FIG. 8d is a topographic display image of a microlens formed by fibroblasts that has been treated with nocodazole. Local areas of high strain can be seen as the peaks on the microlens.

These results demonstrated that the cells can be selected or induced to respond to stimuli that will alter the optical properties of the microlenses.

The versatility of the method for microlenses formation allows for the realization of a variety of functional devices on both planar and non-planar surfaces as demonstrated by the synthetic compound lens structures. The optical nature of the microlenses is shown by a projection experiment illustrated in FIGS. 6a-b. In FIG. 6a, the microlens array is positioned on the sample stage of an optical microscope, where the lens can be used to form a projection image of “UMASS.” The printed image is projected onto the focal plane of a microlens of NIH/3T3 (FIG. 6b, top image) and LLCPK (FIG. 6b, bottom image).

In summary, this approach to deformation, and in particular to pattern generation, is unique for the type of relief structure that can be formed and simplicity in attaining pattern alignment. The alignment of the surface patterns is achieved simply be patterning the substrate. In general, the process is amenable to a wide range of polymers. The general process is amenable to patterning both planar and nonplanar surfaces.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All ranges disclosed herein are inclusive of the endpoints, and the endpoints are independently combinable with each other. The use of the terms “a” and “an” and “the” and similar referents in the context of describing the invention (especially in the context of the following claims) are to be construed to cover both the singular and the plural, unless otherwise indicated herein or clearly contradicted by context. As used here, the prefix “(meth)acryl-” includes both “acryl-” and “methacryl-”. Further, the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A method of deforming a surface, comprising:
exposing a composite article to a plurality of biological contractile cells,
wherein the composite article comprises
a substrate comprising a depression formed on a surface thereof; and
a deformable layer having a first surface and an opposite, second surface, wherein the first surface of the layer is adheringly disposed on the surface of the substrate, and a portion of the layer covers the depression; and
wherein the exposure is for a length of time and under conditions effective for the biological contractile cells to adhere to the second surface of the layer and deform the portion of the second layer covering the depression.

2. The method of claim 1, further comprising adjusting a degree of deformation of the layer during deforming the layer.

3. The method of claim 1, further comprising adjusting a degree of deformation of the layer after deforming the layer.

4. The method of claim 3, wherein adjusting the degree of deformation of the layer comprises substantially reversing the deformation of the layer.

5. The method of claim 4, wherein the adjusting the degree of deformation comprises exposing the contractile cells adhered to the deformed layer to an environmental change effective to modify a degree of contractile ability of the cells.

6. The method of claim 1, further comprising rendering the deformed surface permanent.

7. The method of claim 6, wherein the layer comprises a crosslinkable polymer, and rendering the deformed surface permanent comprises crosslinking the crosslinkable polymer after deforming the layer.

8. A method of forming a microlens array, comprising
exposing a composite article to a plurality of contractile cells,
wherein the composite article comprises
a optically transparent substrate comprising a plurality of depressions having a substantially circular cross section formed on a surface thereof; and
an optically transparent layer having a first surface and an opposite, second surface, wherein the first surface of the layer is adheringly disposed on the surface of the substrate, and a portion of the layer covers the plurality of depressions; and
wherein the exposure is for a length of time and under conditions effective for the contractile cells to adhere to the second surface of the layer and deform the portion of the second layer covering the depression to form the microlens array.

9. A composite article, comprising:
a substrate comprising a depression formed on a surface thereof;
a layer having a first surface and an opposite, second surface, wherein the first surface of the layer is adheringly disposed on the surface of the substrate, and a portion of the layer covers the depression, and the second surface has a surface structure formed thereon; and
contractile cells contacting the second surface of the layer, wherein the contraction of the cells forms the surface structure.

10. The article of claim 9, in the form of a microlens, a microlens array, a compound microlens, a diffraction grating, a microfluidic pump, a photonic crystal, a pressure-sensitive adhesive, a mechanical strain sensor, a microfluidic device, or a cell culture container.
